(19) United States
(12) Patent Application Publication
(10) Pub. No.: US 2012/0171754 A1
(43) Pub. Date: Jul. 5, 2012

(54) STABILIZED ENZYMATIC COMPOSITION

(75) Inventors: Cornelius Bessler, Dusseldorf (DE); Susanne Tondera, Dusseldorf (DE); Sören Hölsken, Dusseldorf (DE)

(73) Assignee: Henkel AG & Co. KGaA, Dusseldorf (DE)

(21) Appl. No.: 13/417,590

(22) Filed: Mar. 12, 2012

Related U.S. Application Data
(63) Continuation of application No. PCT/EP2010/064030, filed on Sep. 23, 2010.

(30) Foreign Application Priority Data
Sep. 28, 2009 (DE) 10 2009 045 064.5

(51) Int. Cl. C11D 3/386; C11D 3/60; C11D 17/00; C12S 11/00; C12S 9/00

(52) U.S. Cl. 435/263; 435/264; 510/465; 510/392; 510/405; 510/403; 510/404

(57) ABSTRACT

The invention relates to compositions comprising enzymes and enzyme stabilizing agents. This is achieved by using an enzyme-stabilizing component which comprises a calcium compound with a bidentate ligand and a phenylboronic acid derivative. Enzyme-containing compositions comprising such an enzyme-stabilizing component are advantageously stable in storage.

### CROSS-REFERENCES TO RELATED APPLICATIONS

This application is a continuation of PCT/EP2010/064030, filed on Sep. 23, 2010, which claims priority under 35 U.S.C. §119 to DE 10 2009 045 064.5 filed on Sep. 28, 2009, both of which are hereby incorporated by reference.

### FIELD OF THE INVENTION

The present invention generally relates to enzyme stabilization. The invention in particular relates to enzyme-containing compositions which contain enzyme-stabilizing compounds. The invention furthermore relates to surfactant preparations which comprise such enzyme-containing compositions, and furthermore proposes uses and methods in which enzymes may be stabilized by such compounds.

### BACKGROUND OF THE INVENTION

Problems relating to the storage stability of enzyme-containing compositions have long been known from the prior art. This issue is particularly pronounced in liquid enzyme-containing compositions, for example liquid washing or cleaning agents. In principle, however, the question of storage stability relates to all enzyme-containing compositions, for example also fermentation supernatants or also non-liquid compositions.

One aim in developing enzyme-containing compositions, in particular washing agents, is to stabilize the enzymes contained therein, in particular during storage. This is taken to mean protection from various unfavorable influences, such as for example from denaturation or degradation by physical influences or oxidation. One focal point of these developments consists in protecting the proteins and/or enzymes contained therein from proteolytic cleavage. This may proceed by creating physical barriers, for instance by encapsulating the enzymes in special enzyme granules or by formulating the agents in two- or multi-chamber systems. Another widely used approach involves adding chemical compounds to the agents which inhibit the enzymes contained therein, in particular proteases, and thus overall act as stabilizers for the proteins and enzymes contained therein. The inhibitors must, however, be reversible inhibitors, since the intention is only temporarily to suppress enzyme activity, in particular protease activity, in particular during storage, but not during subsequent use of the composition, for example during a washing or cleaning process.

Reversible protease inhibitors which are established in the prior art are polyols, in particular glycerol and 1,2-propylene glycol, benzamidine hydrochloride, borax, boric acids, boronic acids or the salts or esters thereof. Among these, derivatives with aromatic groups, for instance ortho-, meta- or para-substituted phenylboronic acids, should in particular be mentioned, in particular 4-formylphenylboronic acid (4-FPBA) or the salts or esters of the stated compounds. The latter-stated compounds are for example disclosed as enzyme stabilizers in international patent application WO 96/41859 A1. Peptide aldehydes, i.e. oligopeptides with a reduced C terminus, in particular those comprising 2 to 50 monomers, are also described for this purpose. Peptidic reversible protease inhibitors include inter alia ovomucoid and leupeptin. Specific, reversible peptide inhibitors and fusion proteins of proteases and specific peptide inhibitors are also used for this purpose. Examples of further enzyme stabilizers are calcium compounds, for example calcium chloride, calcium lactate or calcium acetate. Polyols such as glycerol and 1,2-propylene glycol have, however, proved to be less advantageous enzyme stabilizers in washing and cleaning agents due to the elevated concentrations in which they must be used.

Among those serine protease inhibitors which are already active at a comparatively low concentration, boric acid derivatives are of particular significance as enzyme stabilizers. International patent application WO 96/21716 A1, for example, discloses that boric and boronic acid derivatives active as protease inhibitors are suitable for stabilizing enzymes in washing and cleaning agents. A selection of boronic acid derivatives as stabilizers is for example disclosed in international patent application WO 96/41859 A1. Boric acids and boric acid derivatives do, however, often exhibit the disadvantage that they form undesired secondary products with other ingredients of a composition, in particular washing or cleaning agent ingredients, such that, in the agents in question, the latter are no longer available for the desired cleaning purpose or are even left behind as a contaminant on the washed article. Boric acids or borates are furthermore regarded as disadvantageous from an environmental standpoint.

The object accordingly arose of stabilizing enzymes in a composition and using for this purpose compounds containing less boron as enzyme stabilizers. In particular, the compounds should contain no boric acid.

Use in compositions of an overall liquid, gel-form or pasty nature, for example washing or cleaning agents or disinfectants, and among these in particular those containing water, was of particular interest.

Furthermore, other desirable features and characteristics of the present invention will become apparent from the subsequent detailed description of the invention and the appended claims, taken in conjunction with this background of the invention.

### BRIEF SUMMARY OF THE INVENTION

A composition comprising an enzyme and an enzyme-stabilizing component, wherein the enzyme-stabilizing component comprises a calcium compound with a bidentate ligand and a phenylboronic acid derivative of the structural formula

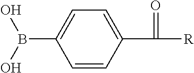

in which R denotes hydrogen, a hydroxyl, a C₁-C₆ alkyl, a substituted C₁-C₆ alkyl, a C₁-C₆ alkenyl or a substituted C₁-C₆ alkenyl group.

Use of a component which contains a calcium compound with a bidentate ligand and a phenylboronic acid derivative of the structural formula

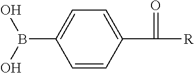

in which R denotes hydrogen, a hydroxyl, a C₁-C₆ alkyl, a substituted C₁-C₆ alkyl, a C₁-C₆ alkenyl or a substituted C₁-C₆ alkenyl group, as enzyme-stabilizing component in a composition which contains an enzyme, in particular in a surfactant preparation.

A method, in particular a washing or cleaning method, in which an enzyme, in particular an enzyme which is selected from the group consisting of protease, amylase, cellulase, hemicellulase, mannanase, tannase, xylanase, xanthanase, β-glucosidase, carrageenase, oxidase, oxidoreductase, lipase, esterase or mixtures thereof, is used, which enzyme is inhibited and/or stabilized by a component which comprises a calcium compound with a bidentate ligand and a phenylboronic acid derivative of the structural formula

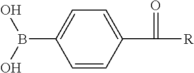

in which R denotes hydrogen, a hydroxyl, a C₁-C₆ alkyl, a substituted C₁-C₆ alkyl, a C₁-C₆ alkenyl or a substituted C₁-C₆ alkenyl group.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides a composition comprising an enzyme and an enzyme-stabilizing component, wherein the enzyme-stabilizing component comprises a calcium compound with a bidentate ligand and a phenylboronic acid derivative of the structural formula

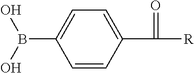

in which R denotes hydrogen, a hydroxyl, a C₁-C₆ alkyl, a substituted C₁-C₆ alkyl, a C₁-C₆ alkenyl or a substituted C₁-C₆ alkenyl group.

For the purposes of the present invention, the enzyme-stabilizing component is a combination of at least two chemical compounds, namely a calcium compound with a bidentate ligand and an appropriate phenylboronic acid derivative. It has surprisingly been found that such a combination of a calcium compound with a bidentate ligand and an appropriate phenylboronic acid derivative stabilizes the enzymes, in particular proteases, surprisingly effectively in a composition, for example in washing and cleaning agents and in particular in liquid washing and cleaning agents, but also in any further, preferably liquid enzyme-containing compositions, for example in a culture supernatant or during processing of a culture supernatant from a fermentation process. The interaction of the two compounds results in synergistic enzyme stabilization. This is taken to mean better enzyme stabilization by means of the combination of the two compounds in comparison with the enzyme stabilization obtained by in each case one of these compounds alone and also relative to the sum of the individual performance of the two compounds with regard to enzyme stabilization. In preferred embodiments of compositions according to the invention, it is consequently possible, thanks to the combination of these compounds, to use the enzyme stabilizers in an overall lower concentration in order achieve at least equivalent enzyme stabilization, for example in washing and cleaning agents. In further preferred embodiments of compositions according to the invention, it is furthermore possible to achieve improved enzyme stabilization with such an enzyme-stabilizing component, preferably without having to make greater use of boron-containing compounds and/or without having to increase the total content of enzyme stabilizers in the composition. In further preferred embodiments of compositions according to the invention, it is furthermore possible with such an enzyme-stabilizing component partially or completely to dispense with boric acid as enzyme stabilizer. In further preferred embodiments of compositions according to the invention, the enzyme stabilizers are those which are suitable as stabilizers/inhibitors for proteases and/or other enzymes, in particular in a washing or cleaning agent or disinfectant.

For the purposes of the present invention, a bidentate (difunctional) ligand complexes a central atom and has two atoms which enter into electrostatic interactions with this central atom. According to the invention, the central atom is calcium, the calcium conventionally assuming the form of a calcium ion.

In a preferred embodiment of the invention, the bidentate ligand of the calcium compound is an alpha-hydroxycarboxylic acid, in particular glycolic acid, lactic acid, malic acid, tartaric acid, citric acid, isocitric acid, mandelic acid, benzilic acid, or the corresponding base. In a further preferred embodiment of the invention, the bidentate ligand of the calcium compound is an alpha-amino acid or a corresponding base. In this respect, any amino acids may in principle be considered, it being possible to use both stereoisomers of the amino acids, thus both D- and L-amino acids, also in combination, or also the polymers or derivatives thereof. In this respect, a polyamino acid comprises at least two amino acid residues. The amino acid is preferably glutamate, aspartate, arginine, lysine, glutamine, histidine, phenylalanine, tyrosine, alanine, leucine, isoleucine, methionine, proline, valine, glutamine, pyrrolysine, selenocysteine, selenomethionine, cysteine, tryptophan, threonine, serine, glycine and asparagine. For the purposes of the present application, amino acid derivatives are taken to mean those substances, the pure amino acid or amino acid chain of which has been modified. Such derivatizations may for example proceed biologically as early as in connection with biosynthesis by a host cell or alternately also by molecular biological methods. They may, however, also be carried out chemically, for instance by the chemical transformation of an amino acid side chain or by covalently bonding another compound to the amino acid or the amino acid chain. Such a compound may, for example, comprise low molecular weight compounds such as lipids or mono-, oligo- or polysaccharides or amines or amine compounds. The amino acids or amino acid chains may furthermore comprise further chemical modifications, in particular they may be glycosylated, hydrolyzed, oxidized, N-methylated, N-formylated, N-acetylated or contain methyl, formyl, ethyl, acetyl, t-butyl, anisyl, benzyl, trifluoroacetyl, N-hydroxysuccinimide, t-butyloxycarbonyl, benzoyl, 4-methylbenzyl, thioanizyl, thiocresyl, benzyloxymethyl, 4-nitrophenyl, benzyloxycarbonyl, 2-nitrobenzoyl, 2-nitrophenylsulfenyl, 4-toluenesulfonyl, pentafluorophenyl, diphenylmethyl, 2-chlorobenzyloxycarbonyl, 2,4,5-trichlorophenyl, 2-bromobenzyloxycarbonyl, 9-fluorenylmethyloxycarbonyl, triphenylmethyl, 2,2,5,7,8-pentamethyl-chromane-6-sulfonyl.

The calcium compound is preferably present in the composition in a concentration of 0.000001 to 10 wt. % and increasingly preferably from 0.00001 to 5 wt. %, from 0.0001 to 2.5 wt. %, from 0.001 to 2 wt. %, from 0.01 to 1.5 wt. % and from 0.1 to 1 wt. %.

For the purposes of the invention, the phenylboronic acid derivative has the following structural formula

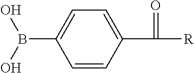

in which the residue R denotes hydrogen, a hydroxyl, a C₁-C₆ alkyl, a substituted C₁-C₆ alkyl, a C₁-C₆ alkenyl or a substituted C₁-C₆ alkenyl group. In preferred phenylboronic acid derivatives, R is a C₁-C₆ alkyl group, with R particularly preferably being CH₃, CH₃CH₂ or CH₃CH₂CH₂. In a further preferred phenylboronic acid derivative, R is hydrogen.

In one very particularly preferred embodiment of the invention, the composition is characterized in that the phenylboronic acid derivative is 4-formylphenylboronic acid (4-FPBA).

The phenylboronic acid derivative is preferably present in the composition in a concentration of 0.000001 to 10 wt. % and increasingly preferably from 0.00001 to 5 wt. %, from 0.0001 to 2.5 wt. %, from 0.001 to 2 wt. %, from 0.01 to 1.5 wt. % and from 0.1 to 1 wt. %.

All the compounds which are provided for the purposes of the present invention as part of the enzyme-stabilizing component may be present in the composition in all protonated and/or deprotonated forms. Furthermore, in comparison with established prior art enzyme stabilizers, for example relative to polyols, these compounds have a lower volume requirement. They moreover have good water solubility, such that they may straightforwardly be incorporated into or straightforwardly used in liquid compositions, in particular in liquid washing or cleaning agents or in a washing liquor formed by a washing or cleaning agent. Furthermore, precipitation during storage is reduced or entirely avoided as a consequence.

For the purposes of the present application, an enzyme should be taken to mean a protein which exercises a specific biocatalytic function. In particular, for the purposes of the present invention, an enzyme present in the composition is selected from the group consisting of: protease, amylase, cellulase, hemicellulase, mannanase, tannase, xylanase, xanthanase, β-glucosidase, carrageenase, oxidase, oxidoreductase, lipase, esterase or mixtures thereof.

A hydrolytic enzyme is preferred according to the invention. In a further preferred embodiment of the invention, the enzyme is a hydrolase (EC 3.X.X.X) and thus an enzyme which hydrolytically cleaves esters, ethers, peptides, glycosides, acid anhydrides or C—C-bonds in a reversible reaction. The hydrolytic enzyme therefore catalyzes the hydrolytic cleavage of substances in accordance with A-B+H₂O [symbol] AH+B—OH. Hydrolases constitute the third main class in the EC enzyme classification. The EC (Enzyme Commission) numbers provide a numerical classification system for enzymes. Each EC number consists of four numbers separated from one another by periods, the first digit denoting one of six main enzyme classes and hydrolases, bearing the number EC 3.X.X.X, accordingly constitute the third main class. Examples of this class are proteases, peptidases, nucleases, phosphatases, glycosidases and esterases. Particularly preferred hydrolases are proteases, amylases, cellulases, hemicellulases, mannanases, tannases, xylanases, xanthanases, β-glucosidases, carrageenases, lipases and esterases. Very particularly preferred hydrolases are proteases which catalyze the hydrolysis of peptide bonds and are consequently capable of cleaving peptides or proteins.

In a further preferred embodiment of the invention, the composition is therefore characterized in that the enzyme is a protease, preferably a serine protease, more preferably a subtilase and particularly preferably a subtilisin. It has been found that such proteases may be particularly effectively stabilized by the enzyme-stabilizing component in a composition according to the invention. In particular for washing and cleaning agents or, in general, enzyme-containing compositions such as highly concentrated enzyme preparations which contain at least one proteolytic enzyme (protease), the storage stability of the enzymes is in fact a general problem. As a result of their enzymatic activity, proteolytic enzymes lead to the hydrolysis of proteins, such as for example enzymes and peptides, which are present in the composition, whether they are other proteins or enzymes or indeed also the proteases themselves. Hydrolysis of the protease by its own proteolytic activity is known as autoproteolysis. The extent of the storage stability of all the proteins/enzymes present in a protein/enzyme composition thus in particular depends on a protease's proteolytic activity in this composition. If the storage stability of all the enzymes in such a composition is to be increased, it is therefore necessary to inhibit precisely the proteolytic activity of the protease during the period of storage. This is most favorably achieved by the addition of an enzyme-stabilizing component for the purposes of the present invention, which component is a specific and reversible inhibitor of the protease present in the composition and has an elevated affinity for the protease.

Among proteases, those of the subtilisin type are preferred. Examples of these are subtilisins BPN′ and Carlsberg, protease PB92, subtilisins 147 and 309, alkaline protease from Bacillus lentus, subtilisin DY and the enzymes thermitase, proteinase K and proteases TW3 and TW7, which are classed among subtilases but no longer among the subtilisins as more narrowly defined. Subtilisin Carlsberg is obtainable in a further developed form under the trade name Alcalase® from Novozymes A/S, Bagsvaerd, Denmark. Subtilisins 147 and 309 are distributed under the trade name Esperase®, or Savinase® by Novozymes. The protease variants sold under the name BLAP® are derived from the protease from Bacillus lentus DSM 5483. Further usable proteases are for example the enzymes obtainable under the trade names Durazym®, Relase®, Everlase®, Nafizym, Natalase®, Kannase® and Ovozymes® from Novozymes, those obtainable under the trade names Purafect®, Purafect® OxP, Purafect® Prime, Excellase® and Properase® from Genencor, that obtainable under the trade name Protosol® from Advanced Biochemicals Ltd., Thane, India, that obtainable under the trade name Wuxi® from Wuxi Snyder Bioproducts Ltd., China, those obtainable under the trade names Proleather® and Protease P® from Amano Pharmaceuticals Ltd., Nagoya, Japan, and that obtainable under the name Proteinase K-16 from Kao Corp., Tokyo, Japan. The proteases from Bacillus gibsonii and Bacillus pumilus are also particularly preferably used, these being disclosed in international patent applications WO2008/086916 and WO2007/131656.

Examples of amylases formulatable according to the invention are the α-amylases from Bacillus licheniformis, from B. amyloliquefaciens or from B. stearothermophilus and the further developments thereof enhanced for use in washing or cleaning agents. The enzyme from B. licheniformis is obtainable from Novozymes under the name Termamyl® and from Genencor under the name Purastar®ST. Further developed products of this α-amylase are obtainable from Novozymes under the trade name Duramyl® and Termamyl®ultra, from Genencor under the name Purastar®OxAm and from Daiwa Seiko Inc., Tokyo, Japan, as Keistase®. The α-amylase from B. amyloliquefaciens is distributed by Novozymes under the name BAN®, and variants derived from the α-amylase from B. stearothermophilus are distributed under names BSG® and Novamyl®, likewise by Novozymes.

Particular note should furthermore be taken for this purpose of the α-amylase from Bacillus sp. A 7-7 (DSM 12368) and the cyclodextrin glucanotransferase (CGTase) from B. agaradherens (DSM 9948). In addition, those amylolytic enzymes may be used which belong to the sequence space of α-amylases, which is defined in international patent application WO 03/002711 (A2), and those which are described in application WO 03/054177 A2. Fusion products of the stated molecules may likewise be used.

Furthermore, the further developments of the α-amylase from Aspergillus niger and A. oryzae obtainable under the trade name Fungamyl® from Novozymes are also suitable.

Further commercial products which may be used are for example Amylase-LT® and Stainzyme® or Stainzyme Ultra® or Stainzyme Plus®, the latter likewise from Novozymes. Variants of these enzymes obtainable by point mutations may also be used according to the invention.

Examples of lipases or cutinases formulatable according to the invention, which are included in particular not only because of their triglyceride-cleaving activity but also to produce peracids in situ from suitable precursors, are the lipases originally obtainable or further developed from Humicola lanuginosa (Thermomyces lanuginosus), in particular those with the amino acid substitution D96L. They are distributed, for example, by Novozymes under the trade name Lipolase®, Lipolase®Ultra, LipoPrime®, Lipozyme® and Lipex®. A further lipase which may advantageously be used is obtainable under the trade name Lipoclean® from Novozymes. Furthermore, the cutinases which were originally isolated from Fusarium solani pisi and Humicola insolens are, for example, also usable. Lipases which are likewise usable are obtainable from Amano under the names Lipase CE®, Lipase P®, Lipase B®, or Lipase CES®, Lipase AKG®, Bacillus sp. Lipase®, Lipase AP®, Lipase M-AP® and Lipase AML®. Lipases or cutinases from Genencor which may, for example, be used are those whose initial enzymes were originally isolated from Pseudomonas mendocina and Fusarium solanii. Further important commercial products which may be mentioned are the preparations M1 Lipase® and Lipomax®, originally distributed by Gist-Brocades, and the enzymes distributed by Meito Sangyo KK, Japan, under the names Lipase MY-30®, Lipase OF® and Lipase PL®, as may the product Lumafast® from Genencor.

Compositions according to the invention may furthermore contain cellulases, depending on the intended purpose as pure enzymes, as enzyme preparations or in the form of mixtures in which the individual components advantageously complement each other with regard to their various performance characteristics. In the case of washing or cleaning agents, these performance characteristics in particular include contributions to the primary or secondary washing performance of the agent (antiredeposition action or graying inhibition), to finishing (fabric action) and even to the provision of a “stone washed” effect.

One usable fungal cellulase preparation with an elevated endoglucanase (EG) content or further developments thereof are offered for sale by Novozymes under the trade name Celluzyme®. The products Endolase® and Carezyme® likewise obtainable from Novozymes are based on the 50 kD EG or the 43 kD EG from H. insolens DSM 1800. Further possible commercial products from this company are Cellusoft®, Renozyme® and Celluclean®. The 20 kD EG cellulase from Melanocarpus, which is obtainable from AB Enzymes, Finland, under the trade names Ecostone® and Biotouch® may also be used. Further commercial products from AB Enzymes are Econase® and Ecopulp®. Further suitable cellulases are obtainable from Bacillus sp. CBS 670.93 and CBS 669.93, the one from Bacillus sp. CBS 670.93 being obtainable from Genencor under the trade name Puradax®. Further commercial products from Genencor are “Genencor detergent cellulase L” and IndiAge®Neutra.

Enzymes which fall within the class of hemicellulases may furthermore be present. These include, for example, mannanases, xanthan lyases, pectin lyases (=pectinases), pectin esterases, pectate lyases, xyloglucanases (=xylanases), pullulanases and β-glucanases. Mannanases suitable in this respect are obtainable, for example, under the names Gamanase® and Pektinex AR® from Novozymes, under the name Rohapec® B1L from AB Enzymes and under the name Pyrolase® from Diversa Corp., San Diego, Calif., USA. The β-glucanase isolated from Bacillus subtilis is obtainable under the name Cereflo® from Novozymes. Hemicellulases particularly preferred according to the invention are mannanases, which are distributed for example under the trade names Mannaway® by Novozymes or Purabrite® by Genencor.

Oxidoreductases, for example oxidases, oxygenases, catalases, (which at low H₂O₂ concentrations react as peroxidase), peroxidases, such as halo-, chloro-, bromo-, lignin, glucose or manganese peroxidases, dioxygenases or laccases (phenol oxidases, polyphenol oxidases) may be present to increase the bleaching action. Suitable commercial products which may be mentioned are Denilite® 1 and 2 from Novozymes. Reference is made, for example systems which may advantageously be used for enzymatic perhydrolysis, to applications WO 98/45398 A1, WO 2005/056782 A2 and WO 2004/058961 A1. A combined enzymatic bleaching system, comprising an oxidase and a perhydrolase is described in application WO 2005/124012. Compounds, preferably organic compounds, particularly preferably aromatic compounds which interact with the enzymes, are advantageously also added in order to enhance the activity of the oxidoreductases in question (enhancers) or, in the event of a major difference in redox potential between the oxidizing enzymes and the soiling, to ensure electron flow (mediators).

The enzymes used according to the invention either originally originate from microorganisms, for instance of the genera Bacillus, Streptomyces, Humicola, or Pseudomonas, and/or are produced by suitable microorganisms using per se known biotechnological methods, for instance by transgenic expression hosts from the genera Bacillus or by filamentous fungi. The enzymes in question are favorably purified by per se established methods, for example by precipitation, sedimentation, concentration, filtration of the liquid phases, microfiltration, ultrafiltration, chemical action, deodorization or suitable combinations of these steps. The enzymes may additionally be formulated together with accompanying substances, for instance from fermentation, or with stabilizers.

Compositions according to the invention preferably contain enzymes in total quantities of 1×10⁻⁸ to 5 wt % relative to active protein. The enzymes are preferably present in a composition according to the invention in amounts from 0.001 to 5 wt. %, more preferably from 0.01 to 5 wt. %, still more preferably from 0.05 to 4 wt % and particularly preferably from 0.075 to 3.5 wt. %, each enzyme which is included possibly being present in the stated quantity ratios. The enzymes may be adsorbed onto carrier substances and/or be embedded in encapsulating substances in order to protect them from premature inactivation Protein concentration may be determined with the assistance of known methods, for example the BCA method (bicinchoninic acid; 2,2′-biquinolyl-4,4′-dicarboxylic acid) or the biuret method (A. G. Gornau, C. S. Bardawill and M. M. David, J. Biol. Chem., 177 (1948), pp. 751-766).

Enzyme stabilization for the purposes of the invention is present when the presence of the enzyme-stabilizing component ensures that, after storage, a composition comprising enzyme and enzyme-stabilizing component exhibits higher enzymatic activity in comparison with a control composition which differs from the composition solely by the absence of the enzyme-stabilizing component. After storage, a composition according to the invention therefore exhibits a higher residual activity of the enzyme in comparison with the control composition, the composition and control composition having exhibited the same initial enzymatic activity at the beginning of storage and both compositions being treated identically, in particular with regard to storage conditions and the determination of enzyme activity. Storage lasts increasingly preferably for at least 24 hours, 48 hours, 72 hours, 5 days, 1 week, 2 weeks, 3 weeks or 4 weeks. Storage further preferably proceeds at a temperature of 20° C., 25° C. or 30° C.

Enzyme activity may be determined in this respect, depending on the particular enzyme type, in conventional manner. Methods for determining activity are familiar to a person skilled in the art in the field of enzyme technology and are routinely used by such persons. Methods for determining protease activity are for example disclosed in Tenside [Surfactants], volume 7 (1970), pages 125-132. Proteolytic activity may furthermore be determined on the basis of the liberation of the chromophore para-nitroaniline (pNA) from the substrate suc-L-Ala-L-Ala-L-Pro-L-Phe-p-nitroanilide (suc-AAPF-pNA). The protease cleaves the substrate and liberates pNA. Liberation of the pNA brings about an increase in absorbance at 410 nm, the time profile of which is a measure of enzymatic activity (cf. Del Mar et al., 1979). The measurement is carried out at a temperature of 25° C., at pH 8.6 and a wavelength of 410 nm. The measurement time amounts 5 min with a measurement interval of 20 s to 60 s. Protease activity is preferably stated in PU (protease units).

The presence of enzyme stabilization is particularly preferably determined using a protease-containing liquid composition, which is stored for two weeks at a temperature of 30° C., and the residual proteolytic activity of which is determined on the basis of the liberation of the chromophore para-nitroaniline (pNA) from the substrate suc-AAPF-pNA.

In a further preferred embodiment of the invention, the composition assumes solid form or liquid, pasty or gel form. Compositions according to the invention may therefore be formulated as solid, liquid or flowable, gel-form, portion-packed or individually portionable, pulverulent, granulated forms, press-molded as tablets, paste-form, sprayable or other conventional presentations. “Flowable” for the purposes of the present application means compositions which can be poured and may exhibit viscosities of up to several tens of thousand mPa·s. Viscosity may be measured with conventional standard methods (for example Brookfield LVT-II viscosimeter at 20 rpm and 20° C., spindle 3) and is preferably in the range from 5 to 10000 mPa·s. Preferred agents have viscosities of 10 to 8000 mPa·s, with values of between 120 and 3000 mPa·s being particularly preferred. Liquid compositions are preferably hydrous.

Compositions according to the invention include all kinds of agents which comprise a composition according to the invention. For example, in addition to washing and cleaning agents and disinfectants, compositions according to the invention also include culture supernatants or presentations obtained during or by processing of a culture supernatant, for example enzyme granules, or liquid enzyme preparations. Particularly preferred compositions for the purposes of the present invention are thus enzyme preparations, enzyme granules, and, with regard to agents, in particular washing and cleaning agents and disinfectants.

The present invention accordingly also provides a surfactant preparation which comprises a composition according to the invention. For the purposes of the present invention, a surfactant preparation is taken to mean any composition which contains at least one surfactant, preferably at least one the surfactants stated below. In one preferred embodiment, the surfactant preparation comprises a dilute or undiluted washing agent, cleaning agent, textile pre- or post-treatment agent or disinfectant. Such agents are preferably referred to below by the term “surfactant preparation”. The textile or the hard surface treated therewith have soiling cleaned from them and/or undergo microbial disinfection.

Washing agents which may be used in this respect are any agents for machine or manual laundering of textiles which are formulated in solid, liquid or flowable, gel-form, portion-packed or individually portionable, pulverulent, granulated forms, press-molded as tablets, paste-form, sprayable or other conventional presentations. Washing agents further include washing auxiliaries, which may be added to the actual washing agent for manual or machine washing of textiles, to achieve a further effect. Cleaning agents include all agents, likewise arising in all the stated presentations, for cleaning hard surfaces, manual and automatic dishwashing agents, carpet cleaners, scouring agents, glass cleaners, WC rimblocks, etc. Finally, textile pre- and post-treatment agents are on the one hand those agents with which an item of laundry is brought into contact before actual washing, for example to partially dissolve stubborn soiling, and on the other hand those which in a step downstream of the actual washing process impart to the washed item further desirable characteristics such as pleasant handle, absence of creases or low static charge. The latter agents include inter alia rinse conditioners. Disinfectants are for example hand disinfectants, surface disinfectants and instrument disinfectants, which may likewise occur in all the stated presentations. A disinfectant preferably reduces the microorganism count by a factor of at least 10⁴, i.e. out of originally 10,000 viable microorganisms (“colony-forming units” or CFU), no more than one survives, viruses in this respect not counting as microorganisms, as they have neither cytoplasm nor their own metabolism. Preferred disinfectants reduce the microorganism count by a factor of at least 10⁵.

Such surfactant preparations may be used as such or after dissolution and/or dilution with water for cleaning textiles and/or hard surfaces. A liquid surfactant preparation may be used as such, but may however also be diluted, in particular with water, by diluting a measured quantity of the surfactant preparation in a further quantity of water in specific ratios by weight of surfactant preparation:water and this dilution is optionally shaken in order to ensure a uniform distribution of the surfactant preparation in the water. Possible weight or volume ratios of the dilutions are from 1:0 surfactant preparation:water to 1:10000 or 1:20000 surfactant preparation:water, preferably from 1:10 to 1:2000 surfactant preparation:water. Furthermore, an originally solid surfactant preparation, thus for example a pulverulent preparation or a preparation in tablet form, may be dissolved in a liquid and preferably in water.

For the purposes of the present invention, a surfactant preparation may therefore also be the washing or cleaning liquor itself. Washing or cleaning liquor is understood to be the working solution containing the washing or cleaning agent, which solution acts on textiles or fabric (washing liquor) or hard surfaces (cleaning liquor) and thus comes into contact with the soiling present on textiles or fabrics or hard surfaces. The washing or cleaning liquor conventionally arises when the washing or cleaning process begins and the washing or cleaning agent is diluted with water for example in a washing machine or in another suitable container.

Surfactants which may in particular be considered are not only anionic surfactants, nonionic surfactants and mixtures thereof, but also cationic, zwitterionic and amphoteric surfactants.

Suitable nonionic surfactants are in particular alkylglycosides and ethoxylation and/or propoxylation products of alkylglycosides or linear or branched alcohols in each case having 12 to 18 C atoms in the alkyl moiety and 3 to 20, preferably 4 to 10, alkyl ether groups. Corresponding ethoxylation and/or propoxylation products of N-alkylamines, vicinal diols, fatty acid esters and fatty acid amides, which correspond with regard to the alkyl moiety to the stated long-chain alcohol derivatives, and of alkylphenols having 5 to 12 C atoms in the alkyl residue may furthermore be used.

Preferably used nonionic surfactants are alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as they are usually present in oxo alcohol residues. In particular, however, alcohol ethoxylates with linear residues prepared from alcohols of natural origin with 12 to 18 C atoms, for example from coconut, palm, tallow fat or oleyl alcohol, and on average 2 to 8 EO per mol of alcohol are preferred. Preferred ethoxylated alcohols include for example C₁₂-C₁₄ alcohols with 3 EU or 4 EO, C₉-C₁₁ alcohols with 7 EU and 2-propylheptanol with 7 EU, C₁₃-C₁₅ alcohols with 3 EO, 5 EO, 7 EO or 8 EO, C₁₂-C₁₈ alcohols with 3 EO, 5 EO or 7 EO and mixtures of these, such as mixtures of C₁₂-C₁₄ alcohol with 3 EO and C₁₂-C₁₈ alcohol with 7 EO. The stated degrees of ethoxylation are statistical averages which, for a specific product, may be an integer or a fractional number. Preferred alcohol ethoxylates have a narrow homologue distribution (narrow range ethoxylates, NRE). In addition to these nonionic surfactants, fatty alcohols with more than 12 EO may also be used. Examples of these are (tallow) fatty alcohols with 14 EO, 16 EO, 20 EO, 25 EO, 30 EO or 40 EO. In particular in surfactant preparations for use in machine methods, extremely low-foaming compounds are conventionally used. These preferably include C₁₂-C₁₈ alkyl polyethylene glycol/polypropylene glycol ethers in each case having up at 8 mol of ethylene oxide and propylene oxide units per molecule. It is, however, also possible to use other nonionic surfactants which are known to be low-foaming, such as for example C₁₂-C₁₈-alkyl polyethylene glycol/polybutylene glycol ethers with in each case up to 8 mol ethylene oxide and butylene oxide units per molecule and end group-terminated alkyl polyalkylene glycol mixed ethers. The alkoxylated alcohols containing hydroxyl groups as described in European patent application EP 0 300 305, or “hydroxy mixed ethers”, are also particularly preferred. Alkyl glycosides of the general formula RO(G)ₓ, in which R means a primary straight-chain or methyl-branched aliphatic residue, in particular methyl-branched in position 2, with 8 to 22, preferably 12 to 18 C atoms and G denotes a glycose unit with 5 or 6 C atoms, preferably glucose, may also be used as nonionic surfactants. The degree of oligomerization x, which indicates the distribution of monoglycosides and oligoglycosides, is any desired number, which as an analytically determined parameter may also assume fractional values, between 1 and 10; x is preferably 1.2 to 1.4. Also suitable are polyhydroxy fatty acid amides of the formula (III), in which R¹CO denotes an aliphatic acyl residue with 6 to 22 carbon atoms, R² denotes hydrogen, an alkyl or hydroxyalkyl residue with 1 to 4 carbon atoms, and [Z] denotes a linear or branched polyhydroxyalkyl residue with 3 to 10 carbon atoms and 3 to 10 hydroxyl groups:

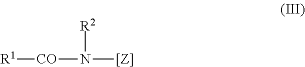

The polyhydroxy fatty acid amides are preferably derived from reducing sugars with 5 or 6 carbon atoms, in particular from glucose. The group of polyhydroxy fatty acid amides also includes compounds of the formula (IV),

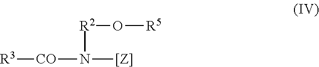

in which R³ denotes a linear or branched alkyl or alkenyl residue with 7 to 12 carbon atoms, R⁴ denotes a linear, branched or cyclic alkylene residue or an arylene residue with 2 to 8 carbon atoms and R⁵ denotes a linear, branched or cyclic alkyl residue or an aryl residue or an oxyalkyl residue with 1 to 8 carbon atoms, C₁-C₄ alkyl or phenyl residues being preferred, and [Z] denotes a linear polyhydroxyalkyl residue, the alkyl chain of which is substituted with at least two hydroxyl groups, or alkoxylated, preferably ethoxylated or propoxylated, derivatives of this residue. [Z] is also here preferably obtained by reductive amination of a sugar such as glucose, fructose, maltose, lactose, galactose, mannose or xylose. The N-alkoxy- or N-aryloxy-substituted compounds may then for example be converted into the desired polyhydroxyfatty acid amides by reaction with fatty acid methyl esters in the presence of an alkoxide as catalyst. A further class of preferably used nonionic surfactants, which may be used either as sole nonionic surfactant or in combination with other nonionic surfactants, in particular together with alkoxylated fatty alcohols and/or alkylglycosides, comprises alkoxylated, preferably ethoxylated or ethoxylated and propoxylated fatty acid alkyl esters, preferably with 1 to 4 carbon atoms in the alkyl chain, in particular fatty acid methyl esters. Nonionic surfactants of the amine oxide type, for example N-coconut alkyl-N,N-dimethylamine oxide and N-tallow alcohol-N,N-dihydroxyethylamine oxide, and of the fatty acid alkanolamide type may also be suitable. The quantity of these nonionic surfactants preferably amounts to no more than that of the ethoxylated fatty alcohols, in particular no more than half the quantity thereof. “Gemini” surfactants may also be considered as further surfactants. These are generally taken to mean such compounds as have two hydrophilic groups per molecule. These groups are generally separated from one another by a “spacer”. This spacer is generally a carbon chain which should be long enough for the hydrophilic groups to be sufficiently far apart that they can act mutually independently. Such surfactants are in general distinguished by an unusually low critical micelle concentration and the ability to bring about a great reduction in the surface tension of water. In exceptional cases, gemini surfactants include not only such “dimeric” surfactants, but also corresponding “trimeric” surfactants. Suitable gemini surfactants are for example sulfated hydroxy mixed ethers or dimer alcohol bis- and trimer alcohol tris-sulfates and ether sulfates. End group-terminated dimeric and trimeric mixed ethers are distinguished in particular by their di- and multifunctionality. The stated end group-terminated surfactants accordingly exhibit good wetting characteristics and are low-foaming, such that they are in particular suitable for use in machine washing or cleaning methods. Gemini polyhydroxyfatty acid amides or poly-polyhydroxyfatty acid amides may however also be used. The sulfuric acid monoesters of linear or branched C₇-C₂₁ alcohols ethoxylated with 1 to 6 mol of ethylene oxide are also suitable, such as 2-methyl-branched C₉-C₁₁ alcohols with on average 3.5 mol of ethylene oxide (EO) or C₁₂-C₁₈ fatty alcohols with 1 to 4 EO. Preferred anionic surfactants also include the salts of alkylsulfosuccinic acid, which are also known as sulfosuccinates or sulfosuccinic acid esters, and are the monoesters and/or diesters of sulfosuccinic acid with alcohols, preferably fatty alcohols and in particular ethoxylated fatty alcohols. Preferred sulfosuccinates contain C₈ to C₁₈ fatty alcohol residues or mixtures thereof. Particularly preferred sulfosuccinates contain a fatty alcohol residue which is derived from ethoxylated fatty alcohols, which are in themselves nonionic surfactants. Sulfosuccinates whose fatty alcohol residues are derived from ethoxylated fatty alcohols with a narrow homologue distribution are here particularly preferred. It is likewise also possible to use alk(en)ylsuccinic acid with preferably 8 to 18 carbon atoms in the alk(en)yl chain or the salts thereof. Further anionic surfactants which may be considered are fatty acid derivatives of amino acids, for example of N-methyltaurine (taurides) and/or of N-methylglycine (sarcosides). Sarcosides or sarcosinates are particularly preferred here and most especially sarcosinates of higher and optionally mono- or polyunsaturated fatty acids such as oleyl sarcosinate. Further anionic surfactants which may in particular be considered are soaps. Saturated fatty acid soaps are in particular suitable, such as the salts of lauric acid, myristic acid, palmitic acid, stearic acid, hydrogenated erucic acid and behenic acid and in particular soap mixtures derived from natural fatty acids, for example coconut, palm kernel or tallow fatty acids. Known alkenylsuccinic acid salts may also be used together with these soaps or as substitutes for soaps.

The anionic surfactants, including the soaps, may be present in the form of the sodium, potassium or ammonium salts thereof and as soluble salts of organic bases, such as mono-, di- or triethanolamine. The anionic surfactants are preferably present in the form of the sodium or potassium salts thereof, in particular in the form of the sodium salts.

Surfactants are preferably present in the surfactant preparation in proportions of 5 wt. % to 50 wt. %, in particular of 8 wt. % to 30 wt. %.

In a further preferred embodiment, the surfactant preparation comprises at least one further ingredient, preferably one which is selected from the group consisting of builder, peroxy compound, bleach activator, alcohol, acid, graying inhibitor, optical brightener, foam inhibitor, water-soluble salt, polymeric thickener, volatile alkali and/or base, hydrophilizing agent, disinfecting ingredient and combinations thereof.

Adding one or more of the further ingredient(s) proves advantageous, as further improved cleaning performance and/or disinfection is achieved thereby. The improved cleaning performance and/or disinfection is preferably based on a synergistic interaction of at least two ingredients. Such a synergistic action may in particular achieved by combining the enzyme, in particular a hydrolytic enzyme and very particularly preferably a protease, with one of the surfactants described above and/or with one of the builders described below and/or with one of the peroxy compounds described below and/or with one of the alcohols described below.

A surfactant preparation for the purposes of the invention may furthermore contain at least one water-soluble and/or water-insoluble, organic and/or inorganic builder. Water-soluble organic builder substances include polycarboxylic acids, in particular citric acid and saccharic acids, monomeric and polymeric aminopolycarboxylic acids, in particular methylglycinediacetic acid, nitrilotriacetic acid and ethylenediaminetetraacetic acid together with polyaspartic acid, polyphosphonic acids, in particular aminotris(methylenephosphonic acid), ethylenediaminetetrakis(methylene-phosphonic acid) and 1-hydroxyethane-1,1-diphosphonic acid, polymeric hydroxyl compounds such as dextrin and polymeric (poly-)carboxylic acids, in particular the polycarboxylates obtainable by oxidizing polysaccharides or dextrins, polymeric acrylic acids, methacrylic acids, maleic acids and copolymers thereof, which may also contain small proportions of polymerizable substances without carboxylic acid functionality incorporated by polymerization. The relative molecular mass of the homopolymers of unsaturated carboxylic acids is in general between 3000 and 200000, that of the copolymers between 2000 and 200000, preferably 30000 to 120000, in each case relative to free acid. One particularly preferred acrylic acid/maleic acid copolymer has a relative molecular mass of 30000 to 100000. Conventional commercial products are for example Sokalan® CP 5, CP 10 and PA 30 from BASF. Suitable, albeit less preferred, compounds of this class are copolymers of acrylic acid or methacrylic acid with vinyl ethers, such as vinyl methyl ethers, vinyl esters, ethylene, propylene and styrene, the acid fraction of which amounts to at least 50 wt. %. Terpolymers containing as monomers two unsaturated acids and/or the salts thereof and, as third monomer, vinyl alcohol and/or an esterified vinyl alcohol or a carbohydrate may also be used as water-soluble organic builder substances. The first acidic monomer or the salt thereof is derived from a monoethylenically unsaturated C₃-C₈ carboxylic acid and preferably from a C₃-C₄ monocarboxylic acid, in particular from (meth)acrylic acid. The second acidic monomer or the salt thereof may be a derivative of a C₄-C₈ dicarboxylic acid, maleic acid being particularly preferred, and/or a derivative of an allylsulfonic acid which is substituted in position 2 with an alkyl or aryl residue. Such polymers generally have a relative molecular mass of between 1000 and 200000. Further preferred copolymers are those which preferably comprise acrolein and acrylic acid/acrylic acid salt or vinyl acetate as monomers. The organic builder substances may be used, in particular for producing liquid surfactant preparations, in the form of aqueous solutions, preferably in the form of 30 to 50 wt. % aqueous solutions. All the stated acids are generally used in the form of the water-soluble salts, in particular the alkali metal salts, thereof.

The indicated molar masses are for the purposes of this document weight-average molar masses Mw of the respective acid form, these having in principle been determined by means of gel permeation chromatography (GPC), a UV detector having been used. Measurement was here made relative to an external polyacrylic acid standard, which supplies realistic molecular weight values as a result of its structural relationship to the polymers under investigation. These values differ markedly from the molecular weight values in which polystyrenesulfonic acids are used as the standard. The molar masses measured relative to polystyrenesulfonic acids are generally markedly higher than the molar masses indicated in the present document.

Such organic builder substances may, if desired, be present in quantities of up to 40 wt. %, in particular of up to 25 wt. % and preferably of 1 wt. % to 8 wt. %. Quantities close to the stated upper limit are preferably used in pasty or liquid, in particular water-containing, surfactant preparations.

Water-soluble inorganic builder materials which may in particular be considered are alkali metal silicates, alkali metal carbonates and alkali metal phosphates, which may be present in the form of the alkaline, neutral or acidic sodium or potassium salts thereof. Examples of these are trisodium phosphate, tetrasodium diphosphate, disodium dihydrogendiphosphate, pentasodium triphosphate, “sodium hexametaphosphate”, oligomeric trisodium phosphate with degrees of oligomerization of 5 to 1000, in particular 5 to 50, and the corresponding potassium salts or mixtures of sodium and potassium salts. Water-insoluble, water-dispersible inorganic builder materials which are used are in particular crystalline or amorphous alkali metal aluminosilicates, in quantities of up to 50 wt. %, preferably of no more than 40 wt. % and, in liquid surfactant preparations, in particular from 1 wt. % to 5 wt. %. Preferred such materials are crystalline sodium aluminosilicates of washing agent grade, in particular zeolite A, P and optionally X, alone or in mixtures, for example in the form of a co-crystallization product of zeolites A and X (Vegobond® AX, a commercial product from Condea Augusta S.p.A). Quantities close to the stated upper limit are preferably used in solid, particulate surfactant preparations. Suitable aluminosilicates in particular comprise no particles with a grain size of above 30 μm and preferably consist to an extent of at least 80 wt. % of particles with a size below 10 μm. Their calcium binding capacity, which may be determined as stated in German patent DE 24 12 837, is generally in the range of from 100 to 200 mg of CaO per gram.

Suitable substitutes or partial substitutes for the stated aluminosilicate are crystalline alkali metal silicates, which may be present alone or mixed with amorphous silicates. The alkali metal silicates usable as builders in the surfactant preparations preferably have a molar ratio of alkali metal oxide to SiO₂ of below 0.95, in particular of 1:1.1 to 1:12 and may be in amorphous or crystalline form. Preferred alkali metal silicates are sodium silicates, in particular amorphous sodium silicates, with an Na₂O:SiO₂ molar ratio of 1:2 to 1:2.8. Preferably used crystalline silicates, which may be present alone or mixed with amorphous silicates, are crystalline phyllosilicates of the general formula Na₂SiₓO₂ₓ₊₁.yH₂O, in which x, the “modulus”, is a number from 1.9 to 22, in particular 1.9 to 4 and y is a number from 0 to 33 and preferred values for x are 2, 3 or 4. Preferred crystalline phyllosilicates are those in which x in the stated general formula assumes the values 2 or 3. In particular, both β- and δ-sodium disilicates (Na₂Si₂O₅.yH₂O) are preferred. Virtually anhydrous crystalline alkali metal silicates, produced from amorphous alkali metal silicates, of the above-stated general formula in which x means a number from 1.9 to 2.1 may also be used for the purposes of the invention in surfactant preparations. A crystalline sodium phyllosilicate with a modulus of 2 to 3, as may be produced from sand and soda, is used in a further preferred surfactant preparation. Crystalline sodium silicates with a modulus in the range from 1.9 to 3.5 are used in a further preferred surfactant preparation. Crystalline layered silicates of the above-stated formula (I) are distributed by Clariant GmbH under the trade name Na-SKS, for example Na-SKS-1 (Na₂Si₂₂O₄₅×H₂O, kenyaite), Na-SKS-2 (Na₂Si₁₄O₂₉×H₂O, magadiite), Na-SKS-3 (Na₂Si₈O₁₇×H₂O) or Na-SKS-4 (Na₂Si₄O₉×H₂O, makatite). Suitable representatives of these are primarily Na-SKS-5 (α-Na₂Si₂O₅), Na-SKS-7 (β-Na₂Si₂O₅, natrosilite), Na-SKS-9 (NaHSi₂O₅.3H₂O), Na-SKS-10 (NaHSi₂O₅.3H₂O, kanemite), Na-SKS-11 (t-Na₂Si₂O₅) and Na-SKS-13 (NaHSi₂O₅), but in particular Na-SKS-6 (δ-Na₂Si₂O₅). In a preferred development of a surfactant preparation for the purposes the invention, a granular compound is used which is prepared from crystalline phyllosilicate and citrate, from crystalline phyllosilicate and above-stated (co)polymeric polycarboxylic acid or from alkali metal silicate and alkali metal carbonate, as is commercially available for example under the name Nabion® 15.

Builder substances are preferably present in the surfactant preparations in quantities of up to 75 wt. %, in particular of 5 wt. % to 50.

Peroxy compounds suitable for use in surfactant preparations for the purposes of the invention which may in particular be considered are organic peracids or peracid salts of organic acids, such as phthalimidopercaproic acid, perbenzoic acid or salts of diperdodecanedioic acid, hydrogen peroxide and inorganic salts which release hydrogen peroxide under washing conditions, which latter include perborate, percarbonate, persilicate and/or persulfate such as caroate. Where solid peroxy compounds are to be used, they may be used in the form of powders or granules, which may also in principle be encapsulated in known manner. If a surfactant preparation contains peroxy compounds, these are preferably present in quantities of up to 50 wt. %, in particular of 5 wt. % to 30 wt. %. It may be appropriate to add small quantities of known bleaching agent stabilizers, such as for example phosphonates, borates or metaborates and metasilicates and magnesium salts such as magnesium sulfate.

Bleach activators which may be used are compounds which, under perhydrolysis conditions, yield aliphatic peroxycarboxylic acids with preferably 1 to 10 C atoms, in particular 2 to 4 C atoms, and/or optionally substituted perbenzoic acid. Suitable substances are those which bear O- and/or N-acyl groups having the stated number of C atoms and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoyl succinimide (NOSI), acylated phenolsulfonates, in particular n-nonanoyl or isononanoyl oxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran and enol ester as well as acetylated sorbitol and mannitol and/or the described mixtures thereof (SORMAN), acylated sugar derivatives, in particular pentaacetyl glucose (PAG), pentaacetyl fructose, tetraacetyl xylose and octaacetyl lactose and acetylated, optionally N-alkylated glucamine and gluconolactone, and/or N-acylated lactams, for example N-benzoylcaprolactam. Hydrophilically substituted acyl acetals and acyl lactams are likewise preferably used. Combinations of conventional bleach activators may also be used. Such bleach activators may be present, in particular in the presence of the above-stated hydrogen peroxide-releasing bleaching agents, in a conventional quantity range, preferably in quantities of 0.5 wt. % to 10 wt. %, in particular 1 wt. % to 8 wt. %, relative to the total surfactant preparation, but are preferably entirely absent when percarboxylic acid is used as the sole bleaching agent.

In addition to or instead of conventional bleach activators, sulfone imines and/or bleach-boosting transition metal salts or transition metal complexes may also be present as “bleach catalysts”.

Organic solvents in addition to water which may be used in the surfactant preparations, in particular if these are in liquid or pasty form, include alcohols with 1 to 4 C atoms, in particular methanol, ethanol, isopropanol and tert.-butanol, diols with 2 to 4 C atoms, in particular ethylene glycol and propylene glycol, and mixtures thereof and the ethers derivable from the stated classes of compounds. Such water-miscible solvents are preferably present in the surfactant preparations in quantities of no more than 30 wt. %, in particular of 6 wt. % to 20 wt. %.

In order to establish a desired pH value which is not automatically obtained by mixing the remaining components, the surfactant preparations may contain acids which are compatible with the system and are environmentally compatible, in particular citric acid, acetic acid, tartaric acid, malic acid, lactic acid, glycolic acid, succinic acid, glutaric acid and/or adipic acid, as well as mineral acids, in particular sulfuric acid, or bases, in particular ammonium or alkali metal hydroxides. Such pH regulators are present in the surfactant preparations in quantities of preferably no more than 20 wt. %, in particular of 1.2 wt. % to 17 wt. %.

Graying inhibitors have the task of keeping dirt which has been dissolved away from the textile fiber suspended in the liquor. Water-soluble colloids of a mainly organic nature are suitable for this purpose, for example starch, size, gelatin, salts of ether carboxylic acids or ether sulfonic acids of starch or cellulose or salts of acidic sulfuric acid esters of cellulose or starch. Water-soluble polyamides containing acidic groups are also suitable for this purpose. Derivatives of starch other than those stated above, for example aldehyde starches, may further be used. Cellulose ethers, such as carboxymethylcellulose (Na salt), methylcellulose, hydroxyalkylcellulose and mixed ethers, such as methylhydroxyethylcellulose, methylhydroxypropylcellulose, methylcarboxymethylcellulose and mixtures thereof, are preferably used, for example in quantities of 0.1 to 5 wt. % relative to the surfactant preparation.

Textile washing agents may for example contain derivatives of diaminostilbene disulfonic acid or the alkali metal salts thereof as optical brighteners, although they preferably contain no optical brighteners for use as a color washing product. Suitable compounds are, for example, salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Brighteners of the substituted diphenylstyryl type may furthermore be present, for example the alkali metal salts of 4,4′-bis(2-sulfostyryl)-diphenyl, 4,4′-bis(4-chloro-3-sulfostyrye-diphenyl, or 4-(4-chlorostyryl)-4′-(2-sulfostyryl)-diphenyl. Mixtures of the above-stated optical brighteners may also be used.

Especially for use in machine methods, it may be advantageous to add conventional foam inhibitors to the surfactant preparations. Suitable foam inhibitors are, for example, soaps of natural or synthetic origin, which comprise an elevated proportion of C₁₈-C₂₄ fatty acids. Suitable non-surfactant foam inhibitors are, for example, organopolysiloxanes and mixtures thereof with microfine, optionally silanized silica as well as paraffins, waxes, microcrystalline waxes and mixtures thereof with silanized silica or bis-fatty acid alkylenediamides. Mixtures of different foam inhibitors are also advantageously used, for example mixtures of silicones, paraffins or waxes. The foam inhibitors, in particular foam inhibitors containing silicone and/or paraffin, are preferably bound to a granular carrier substance which is soluble or dispersible in water. Mixtures of paraffins and bistearylethylenediamide are particularly preferred here.

An surfactant preparation for the purposes of the invention may furthermore contain one or more water-soluble salts, which serve for example to adjust viscosity. The salts may be inorganic and/or organic. Inorganic salts which may be used are preferably selected from the group comprising colorless water-soluble halides, sulfates, sulfites, carbonates, hydrogencarbonates, nitrates, nitrites, phosphates and/or oxides of alkali metals, alkaline earth metals, of aluminum and/or the transition metals; ammonium salts may furthermore be used. Halides and sulfates of alkali metals are particularly preferred; the inorganic salt is therefore preferably selected from the group comprising sodium chloride, potassium chloride, sodium sulfate, potassium sulfate and mixtures thereof. Examples of organic salts which may be used are colorless water-soluble alkali metal, alkaline earth metal, ammonium, aluminum and/or transition metal salts of the carboxylic acids. The salts are preferably selected from the group comprising formate, acetate, propionate, citrate, malate, tartrate, succinate, malonate, oxalate, lactate and mixtures thereof.

A surfactant preparation may contain one or more polymeric thickeners for thickening purposes. Polymeric thickeners are polycarboxylates which, as polyelectrolytes, have a thickening action, preferably homo- and copolymers of acrylic acid, in particular acrylic acid copolymers such as acrylic acid/methacrylic acid copolymers, and polysaccharides, in particular heteropolysaccharides, and other conventional thickening polymers. Suitable polysaccharides or heteropolysaccharides are polysaccharide gums, for example gum arabic, agar, alginates, carrageenan and the salts thereof, guar, guaran, tragacanth, gellan, ramsan, dextran or xanthan and the derivatives thereof, for example propoxylated guar, and the mixtures thereof. Other polysaccharide thickeners, such as starches or cellulose derivatives, may however alternatively preferably be used in addition to a polysaccharide gum, for example starches of the most varied origin and starch derivatives, for example hydroxyethyl starch, starch phosphate esters or starch acetates, or carboxymethylcellulose or the sodium salt thereof, methyl-, ethyl-, hydroxyethyl-, hydroxypropyl-, hydroxypropylmethyl- or hydroxyethylmethyl-cellulose or cellulose acetate.

One preferred polymeric thickener is the microbial anionic heteropolysaccharide xanthan gum, which is produced by Xanthomonas campestris and some other species under aerobic conditions with a molecular weight of 2−15×10⁶ and is obtainable, for example, from Kelco under the trade name Keltrol®, for example as a cream colored powder Keltrol® T (Transparent) or as a white granular product Keltrol® RD (Readily Dispersible).

Acrylic acid polymers suitable as polymeric thickeners are furthermore, for example, high molecular weight homopolymers of acrylic acid crosslinked with a polyalkenyl polyether, in particular an allyl ether of sucrose, pentaerythritol or propylene (INCI Carbomer), which are also known as carboxyvinyl polymers. Such polyacrylic acids are obtainable inter alia from B.F. Goodrich under the trade name Carbopol®, for example Carbopol® 940 (molecular weight approx. 4,000,000), Carbopol® 941 (molecular weight approx. 1,250,000) or Carbopol® 934 (molecular weight approx. 3,000,000). The content of polymeric thickeners conventionally amounts to no more than 8 wt. %, preferably between 0.1 and 7 wt. %, particularly preferably between 0.5 and 6 wt. %, in particular between 1 and 5 wt. % and extremely preferably between 1.5 and 4 wt. %, for example between 2 and 2.5 wt. %.

A surfactant preparation may furthermore contain volatile alkali. Ammonia and/or alkanolamines, which may contain up to 9 C atoms per molecule, are used as such. Among alkanolamines, ethanolamines are preferred and, among these, monoethanolamine is in turn preferred. The content of ammonia and/or alkanolamine preferably amounts to 0.01 to 2 wt. %; ammonia is particularly preferably used. Small quantities of bases may additionally also be included. Preferred bases originate from the group of alkali metal and alkaline earth metal hydroxides and carbonates, in particular of alkali metal hydroxides, among which potassium hydroxide and above all sodium hydroxide are particularly preferred.

A surfactant preparation may also contain a hydrophilizing agent. For the purposes of the present invention, this is taken to mean agents for hydrophilizing surfaces. Colloidal silica sols, in which the silicon dioxide is present preferably in nanoparticulate form, are suitable for hydrophilization. Colloidal nanoparticulate silica sols for the purposes of the present invention are stable dispersions of amorphous particulate silicon dioxide SiO₂ with particle sizes in the range from 1 to 100 nm. The particle sizes are here in the range from 3 to 50 nm, particularly preferably from 4 to 40 nm. One example of a silica sol which is suitable for use for the purposes of the present invention is the silica sol with a particle size of 9 nm obtainable under the trade name Bindzil® 30/360 from Akzo. Further suitable silica sols are Bindzil® 15/500, 30/220, 40/200 (Akzo), Nyacol® 215, 830, 1430, 2034DI and Nyacol® DP5820, DP5480, DP5540 etc. (Nyacol Products), Levasil® 100/30, 100F/30, 10S/30, 200/30, 200F/30, 300F/30, VP 4038, VP 4055 (H.C. Starck/Bayer) or indeed CAB-O-SPERSE® PG 001, PG 002 (aqueous dispersions of CAB-O-SIL®, Cabot), Quartron PL-1, PL-3 (FusoChemical Co.), Köstrosol 0830, 1030, 1430 (Chemiewerk Bad Köstritz). The silica sols used may also be a surface-modified silica which has been treated with sodium aluminate (alumina-modified silica).

In addition, certain polymers may also be used for hydrophilizing surfaces. Suitable hydrophilizing polymers are in particular amphoteric polymers, for example copolymers prepared from acrylic or methacrylic acid and MAPTAC, DADMAC or another polymerizable quaternary ammonium compound. Copolymers with AMPS (2-acrylamido-2-methylpropanesulfonic acid) may furthermore also be used. Polyethersiloxanes, namely copolymers of polymethylsiloxanes with ethylene oxide or propylene oxide segments, are further suitable polymers. Acrylic polymers, maleic acid copolymers and polyurethanes with PEG (polyethylene glycol) units are likewise usable. Suitable polymers are commercially obtainable for example under the trade names Mirapol Surf-S 100, 110, 200, 210, 400, 410, A 300, A 400 (Rhodia), Tegopren 5843 (Goldschmidt), Sokalan CP 9 (BASF) or Polyquart Ampho 149 (Cognis).

A disinfecting ingredient is in particular taken to mean ingredients which have antimicrobial or antiviral efficacy, i.e. which kill microorganisms. The microbicidal action is here dependent on the content of the disinfecting ingredient in the surfactant preparation, the microbicidal action declining with a declining content of disinfecting Ingredient or increasing dilution of the surfactant preparation.

A preferred disinfecting ingredient is ethanol or propanol. Thanks to their solvent properties and microbicidal action, these monohydric alcohols are frequently used in disinfectants and also in cleaning agents in general. The term “propanol” here encompasses both 1-propanol (n-propanol) and 2-propanol (“isopropanol”). Ethanol and/or propanol is/are for example present in the surfactant preparation in a total quantity of 10 to 65 wt. %, preferably of 25 to 55 wt. %. A further preferred disinfecting ingredient is tea tree oil. This is the essential oil of the Australian tea tree (Melaleuca alternifolia), an evergreen shrub native to New South Wales and Queensland from the paperbark (Melaleuca) genus, and further tea tree species from various genera (for example Baeckea, Kunzea and Leptospermum) in the myrtle (Myrtaceae) family. Tea tree oil is obtained by steam distillation from the leaves and twig tips of these trees and is a mixture of approx. 100 substances; the main constituents include (+)-terpinen-4-ol, α-terpinene, terpinolene, terpineol, pinene, myrcene, phellandrene, p-cymene, limonene and 1,8-cineole. Tea tree oil is present, for example, in a quantity of 0.05 to 10 wt. %, preferably of 0.1 to 5.0 wt. %, in the virucidal treatment solution. A further preferred disinfecting ingredient is lactic acid. Lactic acid or 2-hydroxypropionic acid is fermentation product produced by various microorganisms. It has a weak antibiotic action. Lactic acid is present, for example, in quantities of up to 10 wt. %, preferably of 0.2 to 5.0 wt. %, in the surfactant preparation.

Further disinfecting ingredients are for example active ingredients from the groups of alcohols, aldehydes, antimicrobial acids or the salts thereof, carboxylic acid esters, acid amides, phenols, phenol derivatives, diphenyls, diphenyl alkanes, urea derivatives, oxygen or nitrogen acetals and formals, benzamidines, isothiazoles and the derivatives thereof such as isothiazolines and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butylcarbamate, iodine, iodophores and peroxides. Preferred among these active ingredients are those which are preferably selected from the group comprising 1,3-butanediol, phenoxyethanol, 1,2-propylene glycol, glycerol, undecenoic acid, citric acid, lactic acid, benzoic acid, salicylic acid, thymol, 2-benzyl-4-chlorophenol, 2,2′-methylene-bis-(6-bromo-4-chlorophenol), 2,4,4′-trichloro-2′-hydroxydiphenyl ether, N-(4-chlorophenyl)-N-(3,4-dichlorophenyl)urea, N,N′-(1,10-decanediyldi-1-pyridinyl-4-ylidene)-bis-(1-octanamine)dihydrochloride, N,N′-bis-(4-chlorophenyl)-3,12-diimino-2,4,11,13-tetraazatetradecane diimide amide, quaternary surface-active compounds, guanidines. Preferred surface-active quaternary compounds contain an ammonium, sulfonium, phosphonium, iodonium or arsonium group. Disinfecting essential oils, which simultaneously serve to fragrance the virucidal treatment solution, may furthermore also be used. Particularly preferred antimicrobial active ingredients are, however, selected from the group comprising salicylic acid, quaternary surfactants, in particular benzalkonium chloride, peroxide compounds, in particular hydrogen peroxide, alkali metal hypochlorite and mixtures thereof. One such further disinfecting ingredient is for example present in the surfactant preparation in a quantity of 0.01 to 1 wt. %, preferably of 0.02 to 0.8 wt. %, in particular of 0.05 to 0.5 wt. %, particularly preferably of 0.1 to 0.3 wt. %, extremely preferably of 0.2 wt. %.

The ingredients to be selected of the surfactant preparation as well as the conditions under which it is applied according to the invention, such as for example temperature, pH value, ionic strength, redox ratios or mechanical influences, are conventionally optimized for the respective field of application.

In a further embodiment of the invention, the surfactant preparation is characterized in that it contains at least one further stabilizer. Such a preparation therefore contains, in addition to the enzyme-stabilizing component, at least one further compound which effects stabilization of an enzyme contained therein, preferably a protease. A synergistic action is preferably present, i.e. the stabilizing action achieved by the two components exceeds the sum of the two individual stabilizing actions. In a preferred embodiment, the stabilizer(s) comprise(s) one or more polyols, in particular glycerol or 1,2-ethylene glycol, an antioxidant, a lactate or one or more lactate derivatives or combinations thereof. It/they likewise preferably comprise(s) one or more of those enzyme-stabilizing or -inhibiting compounds which are disclosed in international patent applications WO 07/113,241 A1 or WO 02/008398.

The present invention also provides the use of a component which comprises a calcium compound with a bidentate ligand and a phenylboronic acid derivative of the structural formula

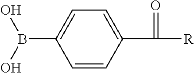

in which R denotes hydrogen, a hydroxyl, a C₁-C₆ alkyl, a substituted C₁-C₆ alkyl, a C₁-C₆ alkenyl or a substituted C₁-C₆ alkenyl group, as enzyme-stabilizing component in a composition which contains an enzyme, in particular in a surfactant preparation.

As has already been explained above, this component effects an advantageous stabilization of the enzyme in an enzyme-containing composition. The composition preferably comprises a liquid composition. Alternatively or in addition, the composition is preferably a surfactant preparation as described above. The enzyme is very particularly preferably a protease.

All factors, aspects and embodiments which have been described for washing or cleaning agents and/or surfactant preparations according to the invention are also applicable to this aspect of the invention. Express reference is therefore made at this point to the disclosure at corresponding points, it being pointed out that this disclosure also applies to the above use according to the invention.

The present invention further provides a method, in which an enzyme, in particular an enzyme which is selected from the group consisting of protease, amylase, cellulase, hemicellulase, mannanase, tannase, xylanase, xanthanase, β-glucosidase, carrageenase, oxidase, oxidoreductase, lipase, esterase or mixtures thereof, is used, which enzyme is inhibited and/or stabilized by a component which comprises a calcium compound with a bidentate ligand and a phenylboronic acid derivative of the structural formula

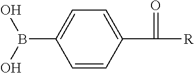

in which R denotes hydrogen, a hydroxyl, a C₁-C₆ alkyl, a substituted C₁-C₆ alkyl, a C₁-C₆ alkenyl or a substituted C₁-C₆ alkenyl group.

As has already been explained above, this component effects an advantageous stabilization of the enzyme. The method is preferably a washing, cleaning or disinfection method. A composition or surfactant preparation as described above is particularly preferably used in such a method.

A method according to the invention preferably proceeds in a temperature range between 10° C. and 60° C., in particular between 10° C. and 50° C., between 10° C. and 40° C., between 10° C. and 30° C. and particularly preferably between 15° C. and 30° C. Thermostable enzymes could even be used at temperatures still higher than 60° C. in methods according to the invention, for example at 70° C. or 75° C. The pH value, at which a method according to the invention is advantageously carried out may depend on the article to the treated. For example, a surfactant preparation which is based on a cleaning agent for toilets, advantageously has an acidic pH value, for example a pH value between pH 2 and pH 5. A surfactant preparation which is based on a textile washing agent or a cleaning agent for other hard surfaces, advantageously has a slightly acidic, neutral or alkaline pH value, for example a pH value between pH 6 and pH 11 or between pH 7 and pH 10. A surfactant preparation which is based on a manual dishwashing agent has for example a pH value of between pH 6.5 and pH 8. If a method according to the invention is to be used in the course of culturing or fermentation of microorganisms, in particular bacteria, or in the course of processing a culture supernatant, the pH value is for example between pH 6.5 and pH 7.5.

All factors, aspects and embodiments which have been described for washing or cleaning agents and/or surfactant preparations according to the invention are also applicable to this aspect of the invention. Express reference is therefore made at this point to the disclosure at corresponding points, it being pointed out that this disclosure also applies to the above methods according to the invention.

### Example

Determination of the storage stability of a liquid washing agent according to the invention

A liquid washing agent with a composition according to Table 1 was used as base formulation (all values in weight percent):

TABLE 1

| | |
|---|---|
| Solvent (polypropylene glycol) | 5 |
| Anionic surfactant (LAS) | 15 |
| Nonionic surfactant (FAEO-7) | 10 |
| Sodium citrate | 3 |
| Soap | 5 |
| Antifoaming agent | 0.01 |
| Protease | 0.045 |
| Optional: enzyme-stabilizing | as stated below |
| component | |
| Demineralized water | ad 100% |

Calcium lactate and 4-formylphenylboronic acid (4-FPBA; Varata Chemicals Ltd., Shanghai, China) were incorporated into this formulation as enzyme-stabilizing component as stated below. Corresponding comparison formulations containing only from Bacillus lentus DSM 5483 according to WO 92/21760 was used as the protease.

Storage was for various periods of time in air-tightly sealed vessels at 30° C. After storage, the respective residual proteolytic activity was determined on the basis of the liberation of the chromophore para-nitroaniline (pNA) from the substrate. The substrate is suc-L-Ala-L-Ala-L-Pro-L-Phe-p-nitroanilide (suc-AAPF-pNA). The protease cleaves the substrate and liberates pNA. Liberation of the pNA brings about an increase in absorbance at 410 nm, the time profile of which is a measure of enzymatic activity (cf. Del Mar et al., 1979). The measurement was carried out at a temperature of 25° C., at pH calcium lactate alone or only 4-FPBA alone were used as controls. The alkaline protease 8.6 and a wavelength of 410 nm. The measurement time was 5 min with a measurement interval of 20 s to 60 s. The activities obtained are stated in Table 2 below, relative to initial activity of 100% at the start of storage.

TABLE 2
Determination of residual proteolytic activity after storage

| Washing agent according to | Start | Week 2 |
|---|---|---|
| Base + 0.1% calcium lactate + 0.01% 4-FPBA | 100% | 108% |
| Base + 0.2% calcium lactate | 100% | 87% |
| Base + 0.02% 4-FPBA | 100% | 79% |

It is clear that the combination of calcium lactate and 4-FPBA as enzyme-stabilizing component leads to a significant increase in storage stability. In the absence of a synergistic effect, a residual activity of between 79% and 87% would have been expected when using the mixture with halved quantities. The combination of calcium lactate and 4-FPBA furthermore results in additional activation of the protease and thus enhanced protease activity. Such additional activation is possible and has already been described for other compounds.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A composition comprising an enzyme and an enzyme-stabilizing component, wherein the enzyme-stabilizing component comprises a calcium compound with a bidentate ligand and a phenylboronic acid derivative of the structural formula 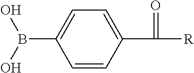
in which R denotes hydrogen, a hydroxyl, a C₁-C₆ alkyl, a substituted C₁-C₆ alkyl, a C₁-C₆ alkenyl or a substituted C₁-C₆ alkenyl group.

2. The composition according to claim 1, wherein the bidentate ligand of the calcium compound is an alpha-hydroxycarboxylic acid, in particular glycolic acid, lactic acid, malic acid, tartaric acid, citric acid, isocitric acid, mandelic acid, benzilic acid, or the corresponding base or an alpha-amino acid or a corresponding base.

3. The composition according to claim 1, wherein the calcium compound is present in a concentration of 0.000001 to 10 wt. %.

4. The composition according to claim 1, in which R is a C₁-C₆ alkyl group or in which R is hydrogen.

5. The composition according to claim 1, wherein the phenylboronic acid derivative is 4-formylphenylboronic acid.

6. The composition according to claim 1, wherein the phenylboronic acid derivative is present in a concentration of 0.000001 to 10 wt. %.

7. The composition according to claim 1, wherein the enzyme is selected from the group consisting of: protease, amylase, cellulase, hemicellulase, mannanase, tannase, xylanase, xanthanase, β-glucosidase, carrageenase, oxidase, oxidoreductase, lipase, esterase or mixtures thereof.

8. The composition according to claim 7, wherein the enzyme is a serine protease.

9. The composition according to claim 1, wherein the enzyme is present in a quantity of 1×10⁻⁸ to 5 weight percent relative to active protein.

10. The composition according to claim 1 in solid, liquid, pasty or gel form.

11. A surfactant preparation comprising the composition according to claim 1.

12. The surfactant preparation according to claim 11, wherein the surfactant preparation furthermore comprises at least one further ingredient which is selected from the group consisting of surfactant, builder, peroxy compound, bleach activator, alcohol, acid, graying inhibitor, optical brightener, foam inhibitor, water-soluble salt, polymeric thickener, volatile alkali and/or base, hydrophilizing agent, disinfecting ingredient and combinations thereof.

13. The surfactant preparation according to claim 12, wherein it contains at least one additional stabilizer selected from the group consisting of glycerol, 1,2-ethylene glycol, an antioxidant, or combinations thereof.

14. A washing method wherein textiles or hard surfaces are contacted with a washing agent comprising an enzyme selected from the group consisting of protease, amylase, cellulase, hemicellulase, mannanase, tannase, xylanase, xanthanase, β-glucosidase, carrageenase, oxidase, oxidoreductase, lipase, esterase or mixtures thereof, is used, and wherein said washing agent further comprises a calcium compound with a bidentate ligand and a phenylboronic acid derivative of the structural formula 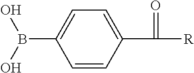
in which R denotes hydrogen, a hydroxyl, a C₁-C₆ alkyl, a substituted C₁-C₆ alkyl, a C₁-C₆ alkenyl or a substituted C₁-C₆ alkenyl group.
